(19) United States
(12) Patent Application Publication
(10) Pub. No.: US 2006/0222945 A1
(43) Pub. Date: Oct. 5, 2006

(54) Battery cathodes

(76) Inventors: William L. Bowden, Nashua, NH (US); Todd E. Bofinger, Nashua, NH (US); Fan Zhang, Needham, MA (US); Joseph E. Sunstrom, Merrimack, NH (US); Rimma A. Sirotina, Ashland, MA (US); Francis Wang, Westford, MA (US)

Correspondence Address: FISH & RICHARDSON P.C., P.O. BOX 1022, MINNEAPOLIS, MN, 55440-1022, US

(21) Appl. No.: 11/096,514

(22) Filed: Apr. 1, 2005

(51) Int. Cl. H01M 4/50; H01M 4/62; H01M 10/40

(52) U.S. Cl. 429/224; 429/232; 429/338; 29/623.1

(57) ABSTRACT

An electrochemical cell includes a cathode including MnO₂ and a CO₂ absorption agent.

### TECHNICAL FIELD

The invention relates to batteries.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through a separator between the electrodes to maintain charge balance throughout the battery during discharge.

There are two basic types of batteries—primary and secondary. Primary batteries generally are discharged to exhaustion once; secondary batteries are designed to be rechargeable and thus can be discharged and recharged multiple times.

Primary lithium batteries typically employ an anode including lithium metal or a lithium alloy; a cathode including an electrochemically active material consisting of a transition metal oxide or chalcogenide, often manganese dioxide (MnO₂); and an electrolyte including a chemically stable lithium salt dissolved in an organic solvent or a mixture of organic solvents. The organic solvents include, for example, carbonate esters such as propylene carbonate and ethylene carbonate. The lithium anode often is formed from a sheet or foil of lithium metal or lithium alloy without any substrate. A lithium primary battery referenced hereinafter as having an anode including lithium shall be understood to mean an anode including lithium metal or a lithium alloy. If a lithium-aluminum alloy is employed, the aluminum often is present in a small amount, for example, less than about one percent by weight of the alloy.

There are various commercial forms of MnO₂ available. Some are produced chemically and are known as “chemically-synthesized manganese dioxide”, or “CMD”. Others are produced electrolytically and are known as “electrolytically-synthesized manganese dioxide”, or “EMD”.

Primary lithium batteries including an MnO₂ cathode may produce gas. At least some of the gas may be generated through the reaction of the cathode with the non-aqueous electrolyte. When the electrolyte includes a carbonate ester, for example, the MnO₂ may react with the ester to generate CO₂.

EMD is the more common-form of MnO₂ used in cathodes for primary lithium batteries. EMD typically is heat treated to remove or reduce surface residual water prior to incorporation into the cathode. Heat treated EMD generally is known as “HEMD”. The EMD that is heat treated to produce HEMD typically has largely a gamma-type structure. The removal of residual water reduces the amount of gas generated during operation of the battery. Methods of making HEMD are described, for example, in Ikeda et al., U.S. Pat. No. 4,133,856, which is incorporated herein by reference.

Iltchev et al., U.S. Pat. No. 6,190,800, incorporated herein by reference, describes a process for producing another type of manganese oxide that can be used in a battery: a heat-treated lithiated MnO₂ (“LiMD”) that largely is in the gamma form. The process described by the Iltchev patent includes treating MnO₂ (e.g., EMD) with a liquid source of lithium cations to promote the ion-exchange of the lithium cations with protons in the crystallographic lattice sites and on surface sites. The lithiated MnO₂ then is heat treated to eliminate or reduce residual water, and to form LiMD.

### SUMMARY

The invention generally relates to MnO₂ cathodes that include a CO₂ absorption agent. “CO₂ absorption agent”, as used herein, means a compound that has the ability to react with CO₂ to form carbonates, which can be relatively unlikely to react with other components of a battery and/or to adversely affect battery performance. The cathodes can be used, for example, in batteries (e.g., primary batteries, such as primary lithium batteries) that include an anode containing lithium or a lithium alloy.

In one aspect, the invention features an electrochemical cell that includes a cathode including MnO₂ and a CO₂ absorption agent, an anode containing lithium, and an electrolyte.

In another aspect, the invention features an electrochemical cell that includes a cathode including MnO₂ and a CO₂ absorption agent, an anode, and a non-aqueous electrolyte.

In an additional aspect, the invention features a cathode for an electrochemical cell, the cathode including MnO₂ and a CO₂ absorption agent.

In a further aspect, the invention features a method of making an electrochemical cell, the method including combining a CO₂ absorption agent with MnO₂ to provide a cathode, and incorporating the cathode into an electrochemical cell.

Embodiments can include one or more of the following features.

The electrochemical cell can be a primary cell or a secondary cell.

The MnO₂ can be gamma-MnO₂. In some embodiments, the MnO₂ can be lithiated. In certain embodiments, the MnO₂ can contain from 0.1 percent to two percent lithium by weight.

The anode can include an alkaline metal. The lithium can be a lithium alloy.

The CO₂ absorption agent can be a metal oxide or a metal hydroxide. The CO₂ absorption agent can be CaO, BaO, Li₂O, Na₂O, SrO, Ca(OH)₂, NaOH, Mg(OH)₂, Al(OH)₃, Sr(OH)₂, LiOH, or soda lime. In certain embodiments, the CO₂ absorption agent may not contain lithium. The cathode can include from 0.1 percent to 15 percent (e.g., from 0.5 percent to 10 percent) of the CO₂ absorption agent by weight.

The electrolyte can be non-aqueous. In some embodiments, the electrolyte can be propylene carbonate or ethylene carbonate.

The method can further include: (a) treating a gamma-MnO₂ material with LiOH and heat to provide a lithiated MnO₂; (b) heating the lithiated MnO₂ to remove moisture; and (c) combining the MnO₂ provided by (b) with the CO₂ absorption agent.

Embodiments can include one or more of the following advantages.

The CO₂ absorption agent can help reduce gassing in the batteries and can make the batteries less likely to leak (e.g., as a result of gas build-up) than comparable batteries that do not include cathodes with a CO₂ absorption agent. In some embodiments, batteries that include the cathodes may be operated without a pre-discharge step to control gassing, and thus may have a relatively high cell capacity and may be easier to manufacture than batteries that are operated with a pre-discharge step. In certain embodiments, batteries including a cathode that has a CO₂ absorption agent can have a relatively high current capability, discharge capacity, and/or closed-circuit voltage (and thus may be used, for example, in a digital camera), while also exhibiting relatively little gas evolution. In some embodiments, the CO₂ absorption agent can be relatively effective in reducing gas evolution, even when present in the cathode in a relatively small amount (e.g., less than about one percent by weight). For example, in some embodiments in which the cathode includes less than about one percent by weight of the CO₂ absorption agent, the CO₂ absorption agent may reduce gas evolution by about 20 percent.

Other features and advantages of the invention will be apparent from the description and drawings, and from the claims.

### DESCRIPTION OF DRAWINGS

FIG. 1 is a sectional view of a nonaqueous electrochemical cell.

FIG. 2 shows a graph of the electrical performance of four different embodiments of a cathode.

FIG. 3 shows a graph of the electrical performance of four different embodiments of a cathode.

FIG. 4 shows a graph of the difference in gassing over time between one embodiment of an electrochemical cell and another embodiment of an electrochemical cell.

FIG. 5 shows a graph of the electrical performance of different embodiments of electrochemical cells.

### DETAILED DESCRIPTION

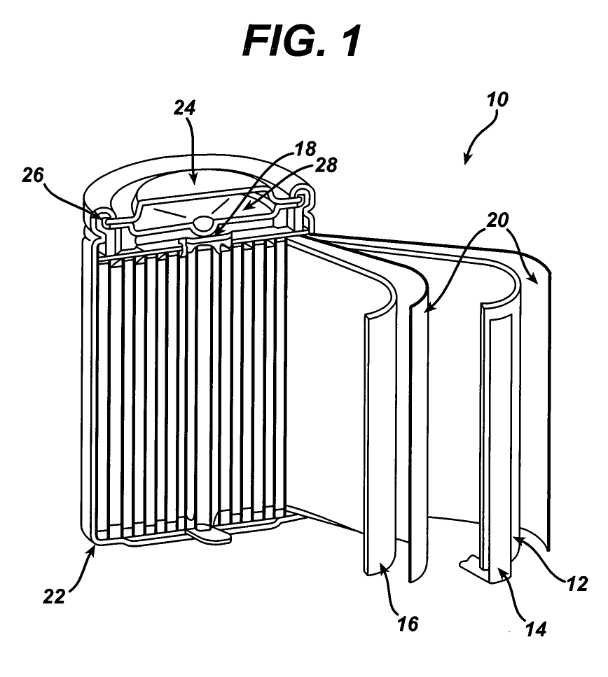

Referring to FIG. 1, a primary electrochemical cell 10 includes an anode 12 in electrical contact with a negative lead 14, a cathode 16 in electrical contact with a positive lead 18, a separator 20 and an electrolytic solution. Anode 12, cathode 16, separator 20 and the electrolytic solution are contained within a housing 22. The electrolytic solution includes a solvent system and a salt that is at least partially dissolved in the solvent system. Electrochemical cell 10 further includes a cap 24 and an annular insulating gasket 26, as well as a safety valve 28. Positive lead 18 connects cathode 16 to cap 24. Safety valve 28 is disposed in the inner side of cap 24 and is configured to decrease the pressure within electrochemical cell 10 when the pressure exceeds some predetermined value.

Cathode 16 includes a cathode active material and a CO₂ absorption agent. In some embodiments, the CO₂ absorption agent may be combined (e.g., mixed) with the cathode active material. In certain embodiments, the cathode active material may be coated with the CO₂ absorption agent.

The cathode active material in cathode 16 can be, for example, a metal oxide, such as a manganese oxide. In some embodiments, the cathode active material can be MnO₂, such as EMD, CMD, gamma-MnO₂, or a combination (e.g., a blend) of any of these materials. Distributors of manganese dioxides include Kerr-McGee Corp. (manufacturer of, e.g., Trona D and high-power EMD), Tosoh Corp., Delta Manganese, Delta EMD Ltd., Mitsui Chemicals, ERACHEM, and JMC. Gamma-MnO₂ is described, for example, in “Structural Relationships Between the Manganese (IV) Oxides”, Manganese Dioxide Symposium, 1, The Electrochemical Society, Cleveland, 1975, pp. 306-327, which is incorporated herein by reference in its entirety. The cathode active material in cathode 16 can be another type of manganese oxide composition. For example, the cathode active material can be HEMD, or can be a lithium manganese oxide composition, such as lithiated MnO₂, or LiMD. In certain embodiments, the cathode active material can be a lithium manganese oxide composition that is formed by the lithiation of MnO₂ and subsequent heat treatment (e.g., at a temperature of at least about 430° C.) of the lithiated MnO₂ in an oxygen atmosphere (e.g., an atmosphere of at least about 70 percent oxygen). In some embodiments, the cathode active material can be MnO₂ that includes from about 0.1 percent to about two percent lithium by weight. Manganese oxide compositions are described, for example, in U.S. patent application Ser. No. 10/761,415, filed on Jan. 22, 2004, and entitled “Cathode Material for Lithium Battery”, and in U.S. patent application Ser. No. 10/951,936, filed on Sep. 28, 2004, and entitled “Battery Cathodes”, both of which are incorporated herein by reference in their entirety.

The CO₂ absorption agent in cathode 16 can be, for example, an oxide, such as a metal oxide. Examples of metal oxides include calcium oxide (CaO), barium oxide (BaO), lithium oxide (Li₂O), sodium oxide (Na₂O), and strontium oxide (SrO). Calcium oxide, barium oxide, lithium oxide, sodium oxide, and strontium oxide can form carbonates out of CO₂ according to the following reactions:
(1) First, CaO reacts with water in the cell: CaO+H₂O→Ca(OH)₂ Then, Ca(OH)₂ reacts with CO₂: Ca(OH)₂+CO₂→CaCO₃+H₂O
(2) First, BaO reacts with water in the cell: BaO+H₂O→Ba(OH)₂ Then, Ba(OH)₂ reacts with CO₂: Ba(OH)₂+CO₂→BaCO₃+H₂O
(3) First, Li₂O reacts with water in the cell: Li₂O+H₂O→2LiOH Then, LiOH reacts with CO₂: 2LiOH+CO₂→Li₂CO₃+H₂O
(4) First, Na₂O reacts with water in the cell: Na₂O+H₂O→2NaOH Then, NaOH reacts with CO₂: 2NaOH+CO₂→Na₂CO₃+H₂O
(5) First, SrO reacts with water in the cell: SrO+H₂O→Sr(OH)₂ Then, Sr(OH)₂ reacts with CO₂: Sr(OH)₂+CO₂→SrCO₃+H₂O

In some embodiments, the CO₂ absorption agent can be a hydroxide, such as a metal hydroxide. Examples of metal hydroxides include calcium hydroxide (Ca(OH)₂), sodium hydroxide (NaOH), magnesium hydroxide (Mg(OH)₂), aluminum hydroxide (Al(OH)₃), strontium hydroxide (Sr(OH)₂), and lithium hydroxide (LiOH). These metal hydroxides can form carbonates out of CO₂ according to the following reactions:
(6) Ca(OH)₂+CO₂→CaCO₃+H₂O
(7) 2NaOH+CO₂→Na₂CO₃+H₂O
(8) Mg(OH)₂+CO₂→MgCO₃+H₂O
(9) 2Al(OH)₃+3CO₂→Al₂(CO₃)₃+3H₂O
(10) Sr(OH)₂+CO₂→SrCO₃+H₂O
(11) 2LiOH+CO₂→Li₂CO₃+H₂O

In certain embodiments, the CO₂ absorption agent may include a mixture of one or more oxides and/or hydroxides. For example, the CO₂ absorption agent can include soda lime, which is a mixture of calcium hydroxide and sodium hydroxide or potassium hydroxide. An example of a commercially available soda lime is SODASORB (from W.R. Grace & Co.). In some embodiments, the CO₂ absorption agent can be soda lime dispersed on a CaO support. In certain embodiments, the CO₂ absorption agent may not include lithium.

In certain embodiments, cathode 16 can include at least about 0.1 percent by weight (e.g., at least about one percent by weight, at least about five percent by weight, at least about 10 percent by weight), and/or at most about 15 percent by weight (e.g., at most about 10 percent by weight, at most about five percent by weight, at most about one percent by weight) of the CO₂ absorption agent. For example, cathode 16 can include from about 0.1 percent by weight to about 15 percent by weight (e.g. from about 0.5 percent by weight to about 10 percent by weight) of the CO₂ absorption agent by weight.

In addition to including a cathode active material and a CO₂ absorption agent, cathode 16 can further include a binder. Examples of binders include polymeric binders, such as PTFE, PVDF, Kraton® and Viton® (e.g., a copolymer of vinylidene difluoride and hexafluoropropylene). In some embodiments, cathode 16 can include a carbon source, such as, for example, carbon black, synthetic graphite including expanded graphite or non-synthetic graphite including natural graphite, an acetylenic mesophase carbon, coke, graphitized carbon nanofibers or a polyacetylenic semiconductor.

Cathode 16 includes a current collector on which the cathode active material can be coated or otherwise deposited. The current collector can have a region in contact with positive lead 18 and a second region in contact with the cathode active material. The current collector serves to conduct electricity between positive lead 18 and the cathode active material. The current collector can be made of a material that is strong and is a good electrical conductor (has a low resistivity). Examples of such materials include metals (e.g., titanium, aluminum) and metal alloys (e.g., stainless steel, an aluminum alloy). In some embodiments, the current collector can take the form of an expanded metal screen or grid, such as a non-woven expanded metal foil. Grids of stainless steel, aluminum, or aluminum alloys are available from Exmet Corporation (Branford, Conn.).

A cathode may be made by coating a cathode material onto a current collector, and drying and then calendering the coated current collector. The cathode material can be prepared by mixing the cathode active material together with other components, such as a binder, solvent/water, and a carbon source. For example, a cathode active material such as MnO₂ may be combined with carbon (e.g., graphite, acetylene black), and mixed with small amount of water to form a cathode slurry. The current collector can then be coated with the cathode slurry. In some embodiments, the CO₂ absorption agent can be mixed with the cathode active material before the cathode active material is mixed with other components of the cathode. In certain embodiments, the CO₂ absorption agent can be added into the cathode slurry, either during or after formation of the cathode slurry. The CO₂ absorption agent may, for example, be incorporated into the cathode slurry during a high shear mixing stage, which can maximize dispersion of the CO₂ absorption agent throughout the cathode.

Cathode 16 can have a relatively high discharge capacity. In some embodiments, cathode 16 can have a discharge capacity of at least about 180 mAh per gram (e.g., at least about 210 mAh per gram, at least about 250 mAh per gram) of cathode active material, and/or at most about 280 mAh per gram (e.g., at most about 250 mAh per gram, at most about 210 mAh per gram) of cathode active material. The discharge capacity of a cathode of a battery can be measured, for example, by discharging the battery on a 100-Ohm resistor to a cut-off voltage of about 1.8 Volts using a Maccor 2300 battery test system, which then calculates the discharge capacity of the cathode.

Anode 12 can include an anode active material, usually in the form of an alkali metal (e.g., lithium, sodium, potassium) or an alkaline earth metal (e.g., calcium, magnesium). In some embodiments, anode 12 can include an alloy of an alkali or alkaline earth metal and one or more other metals. For example, anode 12 can include an alloy of an alkali metal (e.g., lithium) and an alkaline earth metal or an alloy of an alkali metal and aluminum. As an example, anode 12 can include a lithium-aluminum alloy. An anode that includes lithium can include elemental lithium, one or more lithium alloys, one or more lithium-insertion compounds (e.g., LiC₆, Li₄Ti₅O₁₂, LiTiS₂), or a combination thereof. Anode 12 can be used with or without a substrate. In certain embodiments, anode 12 can include both an anode active material and a binder. In such embodiments, the anode active material can include a tin-based material, a carbon-based material (e.g., carbon, graphite, an acetylenic mesophase carbon, coke), a metal oxide, and/or a lithiated metal oxide. The binder can be, for example, polyethylene, polypropylene, a styrene-butadiene rubber, or polyvinylidene fluoride (PVDF). The anode active material and binder can be mixed to form a paste which can be applied, for example, to a substrate of anode 12. Specific anode active materials that are used in a cell may be a function of, for example, the type of cell (such as primary or secondary).

The electrolytic solution or electrolyte can be in liquid, solid or gel (polymer) form. For example, the electrolyte can be a nonaqueous electrolytic solution that includes a solvent and one or more salts. The electrolyte can contain an organic solvent, such as a carbonate, an ether, an ester, a nitrile, or a phosphate. Examples of organic solvents include propylene carbonate (PC), ethylene carbonate (EC), dimethoxyethane (DME) (e.g., 1,2-dimethoxyethane), butylene carbonate (BC), dioxolane (DX), tetrahydrofuran (THF), gamma-butyrolactone, diethyl carbonate (DEC), dimethyl carbonate (DMC), ethyl methyl carbonate (EMC), dimethylsulfoxide (DMSO), methyl formiate (MF), sulfolane, methyl propionate, ethyl propionate, methyl butyrate, gamma-butyrolactone, acetonitrile, triethylphosphate, trimethylphosphate, diethyl ether, dimethyl ether, diethoxyethane, tetrahydrofuran (THF), sulfolane, or a combination (e.g., a mixture) thereof. The electrolyte can alternatively contain an inorganic solvent such as SO₂ or SOCl₂. The electrolyte also can contain one or more salts (e.g., two salts, three salts, four salts). The salt can be an alkali or alkaline earth salt such as a lithium salt, a sodium salt, a potassium salt, a calcium salt, a magnesium salt, or combinations thereof. Examples of lithium salts include lithium tetrafluoroborate, lithium hexafluoroarsenate, lithium perchlorate, lithium iodide, lithium bromide, lithium tetrachloroaluminate, LiN(CF₃SO₂)₂, and LiB(C₆H₄O₂)₂, lithium trifluoromethanesulfonate (LiTFS), lithium trifluoromethanesulfonimide (LiTFSI), lithium hexafluorophosphate (LiPF₆), and combinations thereof. Additional lithium salts that can be included are listed in Suzuki, U.S. Pat. No. 5,595,841, which is incorporated herein by reference in its entirety. A perchlorate salt such as lithium perchlorate can be included in the electrolyte to help suppress corrosion of aluminum or an aluminum alloy in the cell, for example in the current collector. The concentration of the salt in the electrolyte solution can range from 0.01 molar to three molar, from 0.5 molar to 1.5 molar, and in certain embodiments can be one molar. Other salts that can be included in the electrolyte are bis(oxalato)borate salts. Bis(oxalato)borate salts are described, for example, in U.S. patent application Ser. No. 10/800,905, filed on Mar. 15, 2004, and entitled “Non-Aqueous Electrochemical Cells”, which is incorporated herein by reference in its entirety.

Separator 20 can be formed of any of the standard separator materials used in electrochemical cells (e.g., lithium primary or secondary cells). For example, separator 20 can be formed of polypropylene (e.g., nonwoven polypropylene or microporous polypropylene), polyethylene, polytetrafluoroethylene, a polyamide (e.g., a nylon), a polysulfone, a polyvinyl chloride, or combinations thereof. In some embodiments, separator 20 can have a thickness of from about 12 microns to about 75 microns (e.g., from 12 microns to about 37 microns). In certain embodiments, separator 20 can be cut into pieces of a similar size as anode 12 and cathode 16, and placed therebetween as shown in FIG. 1.

Housing 22 can be made of a metal or a metal alloy, such as nickel, nickel plated steel, stainless steel, aluminum-clad stainless steel, aluminum, or an aluminum alloy. Alternatively or additionally, housing 22 can be made of a plastic, such as polyvinyl chloride, polypropylene, a polysulfone, acrylonitrile butadiene styrene (ABS), or a polyamide.

Positive lead 18 can include stainless steel, aluminum, an aluminum alloy, nickel, titanium, or steel. Positive lead 18 can be annular in shape, and can be arranged coaxially with the cylinder of a cylindrical cell. In some embodiments, positive lead 18 can also include radial extensions in the direction of cathode 16 that can engage the current collector. An extension can be round (e.g. circular or oval), rectangular, triangular or another shape. In certain embodiments, positive lead 18 can include extensions having different shapes. Positive lead 18 and the current collector are in electrical contact. Electrical contact between positive lead 18 and the current collector can be achieved by mechanical contact. Alternatively or additionally, positive lead 18 and the current collector can be welded together.

Cap 24 can be made of, for example, aluminum, nickel, titanium, or steel.

Cell 10 can have a relatively high open-circuit voltage, and/or a relatively high closed-circuit voltage. In some embodiments, cell 10 can have an open-circuit voltage of about one Volt or more (e.g., about 1.5 Volts or more, about two Volts or more, about 2.5 Volts or more, about three Volts or more, about 3.2 Volts or more, about 3.3 Volts or more), and/or about 3.5 Volts or less (e.g., about 3.3 Volts or less, about 3.2 Volts or less, about three Volts or less, about 2.5 Volts or less, about two Volts or less, about 1.5 Volts or less). Alternatively or additionally, cell 10 can have a closed-circuit voltage of about 1.1 Volts or more (e.g., about 1.5 Volts or more, about two Volts or more, about 2.8 Volts or more, about 3.1 Volts or more, about 3.3 Volts or more), and/or about 3.4 Volts or less (e.g., about 3.3 Volts or less, about 3.1 Volts or less, about 2.8 Volts or less, about two Volts or less, about 1.5 Volts or less), on a load of about 50 Ohms. In certain embodiments, the closed-circuit voltage of cell 10 can be at least about 60 percent (e.g., at least about 80 percent) of the open-circuit voltage of cell 10.

The closed-circuit voltage of a battery can be measured by, for example, applying a six-ampere constant current load to the battery for 0.1 second and measuring the voltage of the battery. The open-circuit voltage of a battery can be measured by, for example, a high impedance Voltmeter, with an input impedance of greater than 10 MegOhms, so that there is virtually no load on the battery during the test.

In some embodiments, cell 10 can have a relatively high short-circuit current. A cell with a higher short-circuit current than another cell that is otherwise comparable may have a higher current capability than the other cell. In certain embodiments, cell 10 can have a short-circuit current of at least about 10 amperes (e.g., at least about 12 amperes, at least about 15 amperes, at least about 18 amperes, at least about 20 amperes), and/or at most about 25 amperes (e.g., at most about 20 amperes, at most about 18 amperes, at most about 15 amperes, at most about 12 amperes). The short-circuit current of a battery can be measured, for example, by discharging the battery at six amperes for 0.1 second, recording the final voltage, and using linear extrapolation to determine the current at zero Volts.

A cell (e.g., a cylindrical cell) can be prepared by, for example, rolling an anode, separator, and cathode together, and placing them in a housing. The housing (containing the anode, the cathode, and the separator) can then be filled with the electrolytic solution and subsequently hermetically sealed with, for example, a cap and annular insulating gasket.

In some embodiments, a cell (e.g., a cylindrical cell) can be prepared by spirally winding the anode and the cathode together, with a portion of the cathode current collector extending axially from one end of the roll. The portion of the current collector that extends from the roll can be free of cathode active material. To connect the current collector with an external contact, the exposed end of the current collector can be welded to a metal tab, which is in electric contact with an external battery contact. The grid can be rolled in the machine direction, the pulled direction, perpendicular to the machine direction, or perpendicular to the pulled direction. The tab can be welded to the grid to minimize the conductivity of grid and tab assembly. Alternatively, the exposed end of the current collector can be in mechanical contact (i.e. not welded) with a positive lead which is in electric contact with an external battery contact. A cell having a mechanical contact can require fewer parts and steps to manufacture than a cell with a welded contact. In certain embodiments, the effectiveness of the mechanical contact can be enhanced by bending the exposed grid towards the center of the roll to create a dome or crown, with the highest point of the crown over the axis of the roll, corresponding to the center of a cylindrical cell. In the crown configuration, the grid can have a denser arrangement of strands than in the non-shaped form. A crown can be orderly folded and the dimensions of a crown can be precisely controlled.

Methods for assembling electrochemical cells are described, for example, in Moses, U.S. Pat. No. 4,279,972; Moses et al., U.S. Pat. No. 4,401,735; and Kearney et al., U.S. Pat. No. 4,526,846, all of which are incorporated herein by reference.

Other configurations of an electrochemical cell can also be used, including, for example, the button or coin cell configuration, the prismatic cell configuration, the rigid laminar cell configuration, and the flexible pouch, envelope or bag cell configuration. Furthermore, the electrochemical cells can be of different voltages (e.g., 1.5 V, 3.0 V, or 4.0 V). Electrochemical cells are described, for example, in U.S. patent application Ser. No. 10/675,512, filed on Sep. 30, 2003, and entitled “Batteries”; U.S. patent application Ser. No. 10/719,025, filed on Nov. 24, 2003, and entitled “Battery Including Aluminum Component”; and U.S. patent application Ser. No. 10/800,905, filed on Mar. 15, 2004, and entitled “Non-Aqueous Electrochemical Cells”, all of which are incorporated herein by reference.

### EXAMPLES

The following examples are intended to be illustrative and not to be limiting.

### Example 1

Cathode samples were prepared according to the following procedures.

Preparation of Cathode Samples 1A-1D:

One-thousand grams of MnO₂ (Delta EMD lithium grade MnO₂) were heated at a temperature of about 380° C. for about seven hours, to produce HEMD.

Thereafter, the HEMD was evenly divided to form four cathode samples (samples 1A, 1B, 1C, and 1D).

Preparation of Cathode Samples 2A-2D:

One-thousand grams of MnO₂ (Delta EMD lithium grade MnO₂) were heated at a temperature of about 380° C. for about seven hours, to produce HEMD.

The sample 2A cathode active material was then formed by combining about 6.5 grams of the HEMD with about 0.5 gram of Ca(OH)₂, using an agate mortar and pestle for about one to two minutes in a dry room.

The sample 2B cathode active material was formed by combining about 6.5 grams of the HEMD with about 0.5 gram of CaO, using an agate mortar and pestle for about one to two minutes in a dry room.

The sample 2C cathode active material was formed by combining about 6.5 grams of the HEMD with about 0.5 gram of soda lime, using an agate mortar and pestle, under argon, for about one to two minutes in a dry room.

Finally, the sample 2D cathode active material was formed by combining about 6.5 grams of the HEMD with about 0.5 gram of BaO, using an agate mortar and pestle for about one to two minutes in a dry room.

Preparation of Cathode Samples 3A-3D:

Preparation of Lithiated MnO₂:

Twelve-hundred grams of Delta EMD lithium grade MnO₂ (from Delta EMD Ltd.) were placed in a two-liter beaker and dispersed with about one liter of water.

Solid LiOH.H₂O was added into the two-liter beaker with continual stirring while the pH was monitored. When the desired pH of about 12.5 was reached, the slurry of MnO₂ in LiOH solution was put aside and allowed to stand overnight. Without wishing to be bound by theory, it is believed that allowing the lithium hydroxide solution to stand overnight can allow for diffusion of protons and lithium ions within the manganese dioxide to equilibrate, and thereby allow for maximum replacement of protons by lithium.

After the slurry had been allowed to stand overnight, the pH of the slurry was adjusted to the target pH of 12.5 with the addition of more solid LiOH.H₂O.

The slurry was then filtered through a fine porosity glass fritted filter to isolate the lithiated MnO₂. (In some embodiments, a pressure filter can be used instead of a glass fritted filter, such as when relatively large amounts (e.g., five to 10 kilograms) of lithiated MnO₂ are being produced.)

The wet lithiated MnO₂ was then dried overnight at 110° C. to provide about 1200 grams of a dark brown powder.

Heat Treatment of Lithiated MnO₂ in Air:

To remove residual surface and lattice moisture, 1200 grams of the lithiated MnO₂ were then dried at 350° C. for seven hours in air, using the heat treatment procedure described in Iltchev, U.S. Pat. No. 6,190,800, to form LiMD.

The sample 3A cathode active material was formed by combining about 6.5 grams of the LiMD with about 0.5 gram of Ca(OH)₂, using an agate mortar and pestle for about one to two minutes in a dry room.

The sample 3B cathode active material was formed by combining about 6.5 grams of the LiMD with about 0.5 gram of CaO, using an agate mortar and pestle for about one to two minutes in a dry room.

The sample 3C cathode active material was formed by combining about 6.5 grams of the LiMD with about 0.5 gram of soda lime, using an agate mortar and pestle, under argon, for about one to two minutes in a dry room.

Finally, the sample 3D cathode active material was formed by combining about 6.5 grams of the LiMD with about 0.5 gram of BaO, using an agate mortar and pestle for about one to two minutes in a dry room.

Preparation of Cathode Samples 4A-4D:

Preparation of Lithiated MnO₂:

Lithiated MnO₂ was prepared using the process as described above with reference to samples 3A-3D.

Heat Treatment of Lithiated MnO₂ in Oxygen:

One-thousand grams of the lithiated MnO₂ were heated in a retort furnace, in an atmosphere including about 100 percent oxygen. A tank of oxygen was used to provide oxygen flow through the furnace as the lithiated MnO₂ was heated. The lithiated MnO₂ was heated at a temperature of about 450° C., for about 24 hours, to form a lithiated manganese oxide.

The sample 4A cathode active material was formed by combining about 6.5 grams of the lithiated manganese oxide with about 0.5 gram of Ca(OH)₂, using an agate mortar and pestle for about one to two minutes in a dry room.

The sample 4B cathode active material was formed by combining about 6.5 grams of the lithiated manganese oxide with about 0.5 gram of CaO, using an agate mortar and pestle for about one to two minutes in a dry room.

The sample 4C cathode active material was formed by combining about 6.5 grams of the lithiated manganese oxide with about 0.5 gram of soda lime, using an agate mortar and pestle, under argon, for about one to two minutes in a dry room.

Finally, the sample 4D cathode active material was formed by combining about 6.5 grams of the lithiated manganese oxide with about 0.5 gram of BaO, using an agate mortar and pestle for about one to two minutes in a dry room.

Foil-Bag Gas Testing:

Foil-bag gas tests were then conducted on samples 1A-1D, 2A-2D, 3A-3D, and 4A-4D. The results of these foil-bag gas tests are reproduced in Tables 1-4 below. For each of the foil-bag gas tests, 1.8 grams of electrolyte (0.65M LiTFS dissolved in ten percent EC, 20 percent PC, and 70 percent DME), and 7.0 grams of a cathode sample were added into an aluminized Mylar bag. The bag was then sealed and stored at 60° C. for differing lengths of time. Gas evolution was determined by displacement and weight under water.

TABLE 1
Ca(OH)₂ as CO₂ Absorption Agent

| | Sample 1A | | | | | | | |
|---|---|---|---|---|---|---|---|---|
| | (HEMD) | | Sample 2A | | Sample 3A | | Sample 4A | |
| Total Gas After | 23.51 | cm³ | −0.75 | cm³ | −0.72 | cm³ | −1.12 | cm³ |
| 24 Hours | | | | | | | | |
| Total Gas After | 36.63 | cm³ | 3.28 | cm³ | 7.08 | cm³ | −1.02 | cm³ |
| 1 Week | | | | | | | | |
| Total Gas After | 40.75 | cm³ | 8.62 | cm³ | 13.13 | cm³ | −0.96 | cm³ |
| 2 Weeks | | | | | | | | |
| Total Gas After | 44.68 | cm³ | 12.73 | cm³ | 17.21 | cm³ | −0.80 | cm³ |
| 3 Weeks | | | | | | | | |
| Total Gas After | 47.13 | cm³ | 15.28 | cm³ | 20.09 | cm³ | 0.26 | cm³ |
| 4 Weeks | | | | | | | | |

| | | | | |
|---|---|---|---|---|
| Total Gas After | N/A | 32.4% | 42.6% | 0.6% |
| 4 Weeks | | | | |
| Relative to | | | | |
| Sample 1A | | | | |

TABLE 2
CaO as CO₂ Absorption Agent

| | Sample 1B | | | | | | | |
|---|---|---|---|---|---|---|---|---|
| | (HEMD) | | Sample 2B | | Sample 3B | | Sample 4B | |
| Total Gas After | 23.51 | cm³ | 1.67 | cm³ | 12.05 | cm³ | 1.09 | cm³ |
| 24 Hours | | | | | | | | |
| Total Gas After | 36.63 | cm³ | 5.99 | cm³ | 23.83 | cm³ | 5.53 | cm³ |
| 1 Week | | | | | | | | |
| Total Gas After | 40.75 | cm³ | 8.86 | cm³ | 27.78 | cm³ | 7.95 | cm³ |
| 2 Weeks | | | | | | | | |
| Total Gas After | 44.68 | cm³ | 10.13 | cm³ | 30.91 | cm³ | 9.78 | cm³ |
| 3 Weeks | | | | | | | | |
| Total Gas After | 47.13 | cm³ | 11.30 | cm³ | 33.02 | cm³ | 11.01 | cm³ |
| 4 Weeks | | | | | | | | |

| | | | | |
|---|---|---|---|---|
| Total Gas After | N/A | 24.0% | 70.0% | 23.4% |
| 4 Weeks | | | | |
| Relative to | | | | |
| Sample 1B | | | | |

TABLE 3
Soda Lime as CO₂ Absorption Agent

| | Sample 1C | | | | | | | |
|---|---|---|---|---|---|---|---|---|
| | (HEMD) | | Sample 2C | | Sample 3C | | Sample 4C | |
| Total Gas After | 22.73 | cm³ | −2.87 | cm³ | −1.40 | cm³ | −0.68 | cm³ |
| 24 Hours | | | | | | | | |
| Total Gas After | 34.04 | cm³ | −2.51 | cm³ | −0.41 | cm³ | −1.14 | cm³ |
| 1 Week | | | | | | | | |
| Total Gas After | 40.01 | cm³ | 5.04 | cm³ | 4.70 | cm³ | −0.88 | cm³ |
| 2 Weeks | | | | | | | | |
| Total Gas After | 43.46 | cm³ | 12.43 | cm³ | 9.62 | cm³ | 1.29 | cm³ |
| 3 Weeks | | | | | | | | |
| Total Gas After | 45.60 | cm³ | 16.90 | cm³ | 12.67 | cm³ | 4.37 | cm³ |
| 4 Weeks | | | | | | | | |

| | | | | |
|---|---|---|---|---|
| Total Gas After | N/A | 37.1% | 27.8% | 9.6% |
| 4 Weeks | | | | |
| Relative to | | | | |
| Sample 1C | | | | |

TABLE 4
BaO as CO₂ Absorption Agent

| | Sample 1D | | | | | | | |
|---|---|---|---|---|---|---|---|---|
| | (HEMD) | | Sample 2D | | Sample 3D | | Sample 4D | |
| Total Gas After | 22.73 | cm³ | 11.38 | cm³ | 19.01 | cm³ | 10.58 | cm³ |
| 24 Hours | | | | | | | | |
| Total Gas After | 34.04 | cm³ | 18.17 | cm³ | 28.90 | cm³ | 17.48 | cm³ |
| 1 Week | | | | | | | | |
| Total Gas After | 40.01 | cm³ | 21.29 | cm³ | 33.17 | cm³ | 20.38 | cm³ |
| 2 Weeks | | | | | | | | |
| Total Gas After | 43.46 | cm³ | 23.37 | cm³ | 36.01 | cm³ | 22.25 | cm³ |
| 3 Weeks | | | | | | | | |
| Total Gas After | 45.60 | cm³ | 24.43 | cm³ | 37.92 | cm³ | 23.39 | cm³ |
| 4 Weeks | | | | | | | | |

| | | | | |
|---|---|---|---|---|
| Total Gas After | N/A | 53.6% | 83.2% | 51.3% |
| 4 Weeks | | | | |
| Relative to | | | | |
| Sample 1D | | | | |

### Example 2

Six cathode samples (samples 5, 6A-6D, and 7) were prepared according to the following procedures.

Preparation of Lithiated Manganese Dioxide at 25° C.:

Three samples of lithiated manganese dioxide were prepared at three different target pH values: pH 12 (sample 5), pH 12.5 (sample 6), and pH 13 (sample 7), using the following procedure.

Six-hundred grams of EMD (Delta EMD lithium grade MnO₂) were placed in a two-liter beaker and dispersed with about one liter of water.

Solid LiOH.H₂O (from Fisher) was added to the beaker with continual stirring, while the pH of the contents of the beaker was monitored.

When the desired target pH (noted above) was reached, the slurry of MnO₂ in LiOH solution was put aside and allowed to stand overnight (for about 16 hours) at about 25° C.

After the slurry had been allowed to stand overnight, the pH of the slurry typically was within about 0.1 pH unit of the target pH. Additional solid LiOH.H₂O was then added to the slurry to adjust the pH of the slurry to the target pH.

After the target pH was reached, the slurry was filtered through a fine porosity glass fritted filter to isolate the lithiated manganese dioxide (to make kilograms of the lithiated manganese dioxide, a pressure filter can be used).

The wet manganese dioxide was then dried overnight (for about 16 hours) under vacuum at 110° C. to provide a dark brown powder.

Heat Treatment of Lithiated Manganese Dioxide in Air at 350° C.:

Approximately 300 grams of each of samples 5, 6, and 7 were heated in air at 350° C. for seven hours, using the heat treatment procedure described in Iltchev et al., U.S. Pat. No. 6,190,800, to form LiMD.

Addition of CO₂ Absorption Agent:

Sample 6 was then divided evenly into four smaller samples 6A-6D, each in the amount of about 75 grams.

Sample 6A was combined with CaO, using an agate mortar and pestle for about one to two minutes in a dry room. A sufficient amount of CaO was combined with sample 6A until sample 6A included about 0.7 percent by weight CaO.

Sample 6B was combined with Ca(OH)₂, using an agate mortar and pestle for about one to two minutes in a dry room. A sufficient amount of Ca(OH)₂ was combined with sample 6B until sample 6B included about 0.7 percent by weight Ca(OH)₂.

Sample 6C was combined with CaO, using an agate mortar and pestle for about one to two minutes in a dry room. A sufficient amount of CaO was combined with sample 6C until sample 6C included about seven percent by weight CaO.

Sample 6D was combined with Ca(OH)₂, using an agate mortar and pestle for about one to two minutes in a dry room. A sufficient amount of Ca(OH)₂ was combined with sample 6D until sample 6D included about seven percent by weight Ca(OH)₂.

Digital Camera Test:

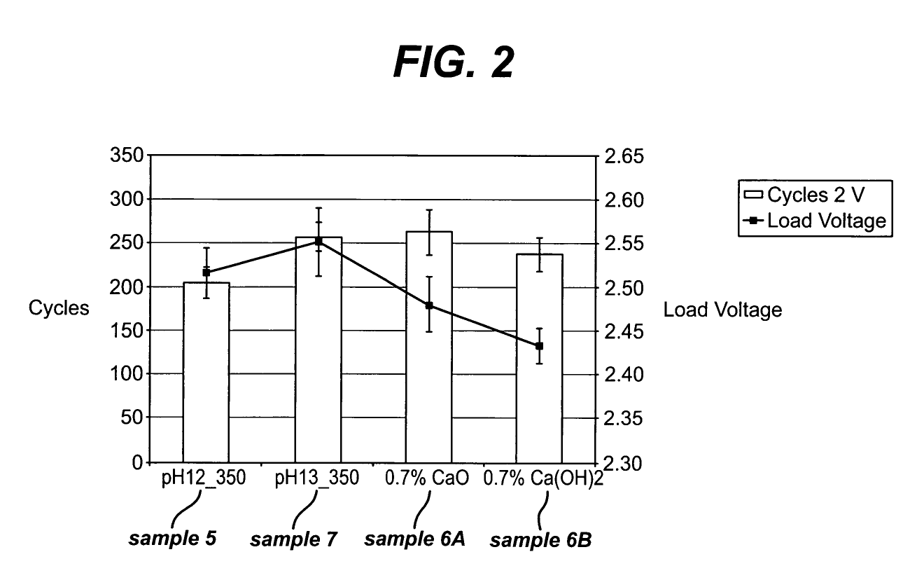

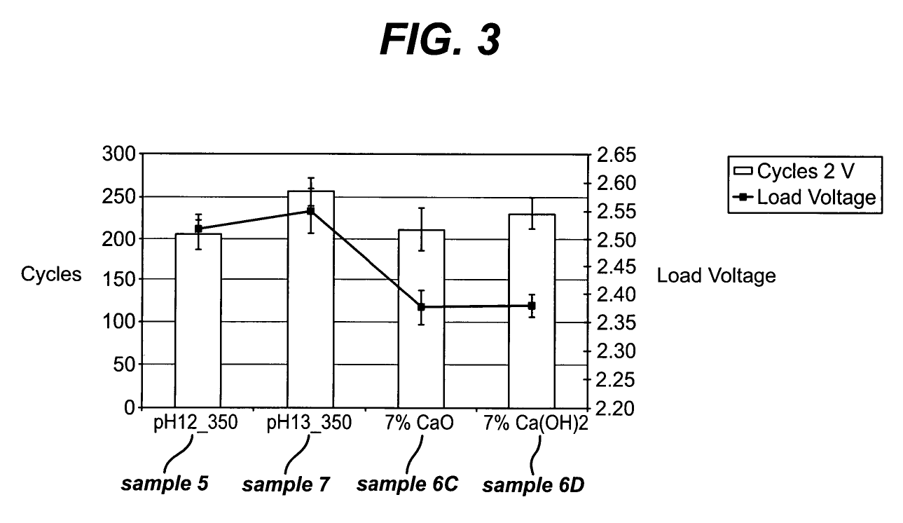

Referring now to FIGS. 2 and 3, the results of a “digital camera” test at room temperature are shown for test cells that included one of samples 5, 6A-6D, or 7. The digital camera test was performed using a Maccor 2300 series benchtop battery test system, available from Maccor. The digital camera test simulated the working conditions of a digital camera by subjecting the test cells to a number of pulses, each pulse having a specific power load and lasting for a specific amount of time (provided in Table 5), to a two-Volt cut-off. During the digital camera test, six 2430-size coin cells, each filled with 0.3 gram of one of samples 5, 6A-6D, or 7, were tested. The cells also included an electrolyte (a mixture of EC, PC, and DME). For comparison, one 2430-size coin cell filled with 0.3 gram of β-EMD (from Delta) was used as a control cell. The results of the digital camera test for samples 5, 6A, 6B, and 7 in fresh cells (cells that had not been discharged prior to the test) are shown in FIG. 2, and the results of the digital camera test for samples 5, 6C, 6D, and 7 in fresh cells are shown in FIG. 3. For each of the samples shown in FIGS. 2 and 3, the total number of cycles to the cut-off voltage was recorded. (Each pulse to which a cell responded was considered to be a cycle.)

Table 5, below, shows the test protocol for the digital camera test. Each 2430-size coin cell was first subjected to a “Flash On-LCD On” portion of the test, which included a series of pulses, and was then subjected to a “Flash Off-LCD On” portion of the test, which also included a series of pulses. Each pulse (listed as a “step” in the table) was designed to mimic a function of the camera, and to provide the corresponding draw from the battery. For example, step 1 corresponded to the draw required by the LCD of a camera, step 2 corresponded to the zoom feature of a camera, steps 3, 5, 7, and 9 corresponded to the process function of a camera (which drives the microprocessor of the camera), step 4 corresponded to the autofocus feature of a camera, step 6 corresponded to the shutter function of a camera, step 8 corresponded to the flash recharging function of a camera, step 10 corresponded to the LCD standby function of a camera (in which the camera display is on, although the camera is on standby), and step 11 corresponded to the rest function of a camera (in which there is no load on the battery). Table 5 also shows the time (in seconds) for each step, as well as the load (in Watts) of each step on the 2430-size coin cells, and what the corresponding load (in Watts) of each step would have been on a ⅔ A cell.

TABLE 5

| | FLASH ON - LCD ON | | | | FLASH OFF - LCD ON | | | |
|---|---|---|---|---|---|---|---|---|
| | | | Load (W) | | | | Load (W) | |
| | | | Sample | | | | Sample | |
| | | Load (W) | (2430-Size | Time | | Load (W) | (2430-Size | Time |
| Function | Step | 2/3 A Cell | Coin Cell) | (s) | Step | 2/3 A Cell | Coin Cell) | (s) |
| LCD | 1 | 2.9 | 0.0829 | 0.5 | 1 | 2.9 | 0.0829 | 0.5 |
| Zoom | 2 | 4.87 | 0.1391 | 0.5 | 2 | 4.87 | 0.1391 | 0.5 |
| Process | 3 | 2.9 | 0.0829 | 1 | 3 | 2.9 | 0.0829 | 2 |
| Autofocus | 4 | 4.87 | 0.1391 | 0.5 | 4 | 4.87 | 0.1391 | 0.5 |
| Process | 5 | 2.9 | 0.0829 | 1 | 5 | 2.9 | 0.0829 | 1 |
| Shutter | 6 | 6 | 0.1714 | 0.1 | 6 | 6 | 0.1714 | 0.1 |
| Process | 7 | 2.9 | 0.0829 | 1 | 7 | 3 | 0.0857 | 2.4 |
| Flash | 8 | 5 | 0.1429 | 1 | | | | |
| Recharge | | | | | | | | |
| Process | 9 | 3 | 0.0857 | 0.4 | | | | |
| LCD | 10 | 2.9 | 0.0829 | 14 | 10 | 2.9 | 0.0829 | 13 |
| Standby | | | | | | | | |
| Rest | 11 | 0 | 0 | 40 | 11 | 0 | 0 | 40 |

### Example 3

Two different types of ⅔A cells (cell samples 8 and 9) were prepared according to the following procedures. Six cells of each sample were prepared at a time. The testing results provided below are for one batch of six sample 8 cells and one batch of six sample 9 cells. The testing results for each sample reflect the average of the testing results for the six cells of that sample.

Cathode Preparation:

Cathodes for the ⅔A cells were prepared as follows.

Preparation of Mull Mix:

First, a precursor mull mix was prepared. The amount of each component used to prepare the mull mix is shown in Table 6:

TABLE 6

| | | Concentration |
|---|---|---|
| Material | Amount (grams) | (percent by weight) |
| Lithiated EMD | 2802 | 93.4 |
| Graphite | 66 | 2.2 |
| Acetylene Black Carbon | 132 | 4.4 |

The lithiated EMD used in the mull mix was prepared as follows.

Approximately six kilograms of alkaline-grade MnO₂ (from Kerr-McGee (Trona-D)) were added into a 30-liter reaction tank. Approximately six liters of 1M sulfuric acid were then added into the tank. The contents of the tank were stirred periodically over a period of about two hours.

The powder was allowed to settle to the bottom of the tank, and liquid was decanted using Tygon tubing as a siphon.

The resulting powder was rinsed by adding about 20 liters of deionized water and stirring for two minutes. After the solids had been allowed to settle out, the wash water was decanted. The powder washing was then repeated.

Approximately six liters of 1M sulfuric acid were added to the tank and the contents of the tank were allowed to sit overnight.

Then, fresh deionized water was added in a ratio of one liter of water to one kilogram of MnO₂. The initial pH of the mixture was recorded and the contents of the tank were stirred.

About 225 to 260 grams of solid LiOH.H₂O were added into the tank in 20-30 gram increments, over a period of about 20 to 30 minutes (allowing the pH of the mixture to settle at about ph 13 between additions of LiOH.H₂O). The tank was covered and the contents were stirred overnight.

The stirring was then turned off and the solids were allowed to settle out of solution (for about 45 minutes). The mixture was then filtered using a pressure filter, resulting in a solid cake of material.

The cake was transferred from the filter to a conventional oven, where it was dried at a temperature of between 60° C. and 90° C. The resulting dried cake was then ground using a mortar and pestle, resulting in a lithiated MnO₂ powder.

Thereafter, about 1,000-1,200 grams of the lithiated MnO₂ powder were heated in a muffle furnace outfitted with a retort insert, in an atmosphere including about 100 percent oxygen. A tank of oxygen was used to provide oxygen flow through the furnace as the lithiated MnO₂ was heated. The lithiated MnO₂ was heated at a temperature of about 450° C., for about 24 hours, to form a lithiated manganese oxide (lithiated EMD).

The lithiated EMD, the graphite, and the acetylene black carbon were weighed and added to a high-shear mixer (a Henschel mixer). The contents were mixed dry for 20 to 40 minutes at a rotational speed of about 2800 RPM. The mixing time for each batch of mull mix that was made was determined by measuring the Scott Apparent Density (SAD) of the mix in five-minute intervals. When the SAD was between 14.75 grams and 16.39 grams, the mixing was stopped. The procedure was repeated until a total of about 8,000 grams of mull mix had been produced. The mull mix was then divided into three batches of equal amounts.

Preparation of Cathode Paste:

Next, the cathode paste was prepared. The relative amount of each component used to prepare the wet cathode paste for each cell is shown in Table 7:

TABLE 7

| | Sample 8 - | Sample 9 - |
|---|---|---|
| | Concentration | Concentration |
| Material | (percent by weight) | (percent by weight) |
| Mull Mix | 68.4 | 65.7 |
| CaO | 0 | 0.7 |
| Isopropyl Alcohol | 27.1 | 29.2 |
| PTFE (Teflon Binder) | 4.4 | 4.5 |

The cathode paste for each cell was prepared by mixing equivalent amounts of mull mix and isopropyl alcohol in a six-quart KitchenAid stand mixer. The contents were mixed at a low speed until the powder was fully wetted, and a paste with a smooth, lump-free texture was obtained (about 10 to 15 minutes). At this point, the paste had a texture similar to that of household ceiling paint. An aqueous PTFE (Teflon) suspension was then added to the paste, and the paste was mixed at the lowest setting for one to three minutes. As the Teflon was worked into the paste, the slurry began to coalesce and to pull away from the sides of the mixing bowl. Once the operator could handle the paste without the paste leaving a residue after handling, the Teflon was determined to be fully incorporated into the paste.

Preparation of Cathodes:

After the cathode paste had been prepared, the cathodes were prepared. The relative amount of each component in the cathode coating is shown in Table 8:

TABLE 8

| | Sample 8 - | Sample 9 - |
|---|---|---|
| | Concentration | Concentration |
| Material | (percent by weight) | (percent by weight) |
| Mull Mix | 96.26 | 94.90 |
| CaO | 0 | 0.96 |
| PTFE (Teflon Binder) | 3.74 | 4.15 |

The cathode for each cell was prepared by cutting a stainless steel expanded metal grid into sheets of eight inches by nine inches. A ribbon of cathode paste was placed on one side of a sheet, along one of the nine-inch wide edges. The sheet was then placed between two layer of adsorbent blotter paper, and was loaded into a mechanical roller (a Rondo roller), with the paste edge of the sheet serving as the leading edge. A gap setting of about 0.2 inch was used on the Rondo roller. After the sheet was passed through the Rondo roller, excess material was removed from the coated sheet and the process was repeated for the uncoated side of the sheet. The double-sided sheet was then suspended on a drying rack and air-dried to remove the isopropyl alcohol in the cathode paste. The thickness of the cathode sheet after drying ranged from 0.017 inch to 0.30 inch. The dried cathode sheet was compacted by feeding the sheet through a calender mill, which reduced the thickness of the cathode sheet down to about 0.016 inch.

After the cathode sheet had been prepared, calendered cathodes were cut to the desired length using a steel-tool knife and slit to the desired width using a hardened steel roller knife. One edge of each of the cut cathodes was then cleared of its cathode coating using an ultrasonic device, thereby exposing the metal grid (for contact with the battery housing).

Cell Preparation:

Cell samples 8 and 9 were prepared by adding the cathode, an anode, an electrolyte, and a separator into a nickel-plated cold rolled steel can.

The anode included lithium metal doped with 0.15 percent by weight aluminum, and had a weight of 0.526 to 0.606 gram, a length of 9.5 inches, a width of 0.97 inch, and a thickness of 0.007 inch.

The electrolyte included 11.4 to 11.8 weight percent ethylene carbonate, 22.9 to 23.6 weight percent propylene carbonate, 56.1 to 57.2 weight percent dimethoxyethane, 500 to 600 ppm LiNO₃, and 7.4 to 9.6 weight percent LiSO₃CF₃.

The separator was microporous polypropylene (Celgard 2400™, Celgard Inc.), and had a weight of 0.2 to 0.26 gram, a length of 11.235 to 11.265 inches, a width of 1.145 to 1.175 inches, and a thickness of 0.001 inch.

In-Cell Gas Testing:

In-cell gas tests were conducted on cell samples 8 and 9. In an in-cell gas test, each cell is first pre-discharged by about six percent to about eight percent. The cell is then sealed in an aluminized Mylar bag and stored at 60° C. Gas evolution is determined by displacement and weight under water.

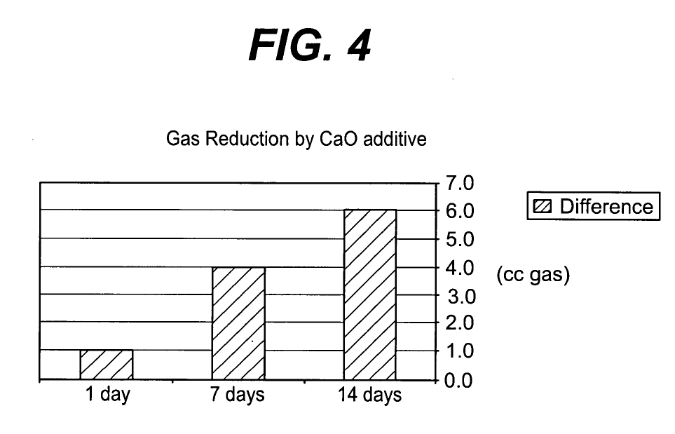

FIG. 4 shows the difference in gassing during the in-cell gas test between the sample 9 cells (which included CaO) and the sample 8 cells (which did not include CaO). As FIG. 4 shows, the sample 9 cells experienced less gassing over time than did the sample 8 cells. For example, after 14 days of in-cell gas testing, the sample 8 cells had released about six cubic centimeters more gas on average than the sample 9 cells.

Digital Camera Test:

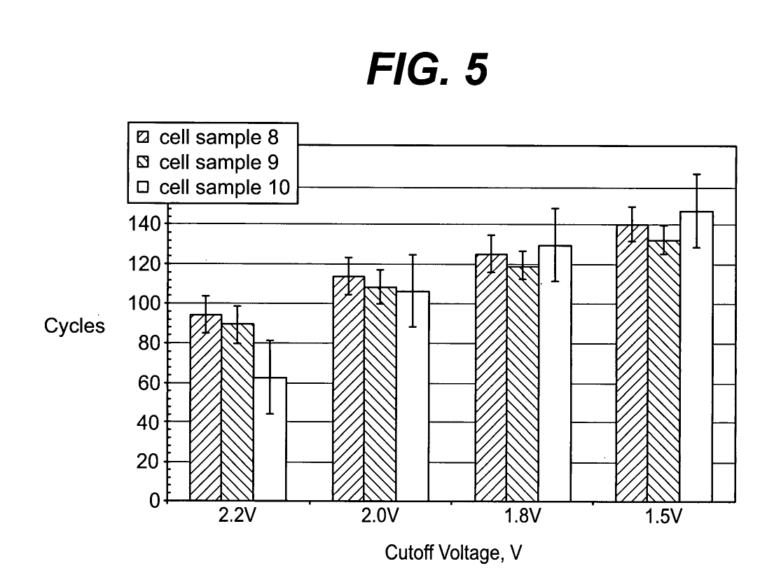

Referring now to FIG. 5, the results of a “digital camera” test at room temperature are shown for cell samples 8 and 9. Cell sample 10 was also tested, and included the same components as cell samples 8 and 9, with the exception that the cathode active material in cell sample 10 was HEMD.

The digital camera test was performed using a Maccor 2300 series benchtop battery test system, available from Maccor. The digital camera test simulated the working conditions of a digital camera by subjecting the test cells to a number of pulses, each pulse having a specific power load and lasting for a specific amount of time (provided in Table 9), to a cut-off voltage of 2.2V Volts, 2.0 Volts, 1.8 Volts, or 1.5 Volts. For each of the cell samples, the total number of cycles to the cut-off voltage was recorded. (Each pulse to which a cell responded was considered to be a cycle.) Table 9, below, shows the test protocol for the digital camera test. Each cell sample was first subjected to a “Flash On-LCD On” portion of the test, which included a series of pulses, and was then subjected to a “Flash Off-LCD On” portion of the test, which also included a series of pulses. Each pulse (listed as a “step” in the table) was designed to mimic a function of the camera, and to provide the corresponding draw from the battery. For example, step 1 corresponded to the draw required by the LCD of a camera, step 2 corresponded to the zoom feature of a camera, steps 3, 5, 7, and 9 corresponded to the process function of a camera (which drives the microprocessor of the camera), step 4 corresponded to the autofocus feature of a camera, step 6 corresponded to the shutter function of a camera, step 8 corresponded to the flash recharging function of a camera, step 10 corresponded to the LCD standby function of a camera (in which the camera display is on, although the camera is on standby), and step 11 corresponded to the rest function of a camera (in which there is no load on the battery). Table 9 also shows the time (in seconds) for each step, as well as the load (in Watts) of each step on the ⅔ A-sized cell samples 8 and 9.

TABLE 9

| | FLASH ON - LCD ON | | | FLASH OFF - LCD ON | | |
|---|---|---|---|---|---|---|
| | | Load (W) | | | Load (W) | |
| Function | Step | 2/3 A Cell Sample | Time (s) | Step | 2/3 A Cell Sample | Time (s) |
| LCD | 1 | 2.9 | 0.5 | 1 | 2.9 | 0.5 |
| Zoom | 2 | 4.87 | 0.5 | 2 | 4.87 | 0.5 |
| Process | 3 | 2.9 | 1 | 3 | 2.9 | 2 |
| Autofocus | 4 | 4.87 | 0.5 | 4 | 4.87 | 0.5 |
| Process | 5 | 2.9 | 1 | 5 | 2.9 | 1 |
| Shutter | 6 | 6 | 0.1 | 6 | 6 | 0.1 |
| Process | 7 | 2.9 | 1 | 7 | 3 | 2.4 |
| Flash | 8 | 5 | 1 | | | |
| Recharge | | | | | | |
| Process | 9 | 3 | 0.4 | | | |
| LCD | 10 | 2.9 | 14 | 10 | 2.9 | 13 |
| Standby | | | | | | |
| Rest | 11 | 0 | 40 | 11 | 0 | 40 |

As FIG. 5 shows, the presence of CaO in the cathode of cell sample 9 did not have a significant adverse impact on the performance of cell sample 9 in the digital camera test.

### Other Embodiments

While certain embodiments have been described, other embodiments are possible.

As an example, in some embodiments, a cathode can include more than one CO₂ absorption agent. For example, a cathode can include three, four, or five different CO₂ absorption agents.

As another example, while electrochemical cells with cathodes that include a CO₂ absorption agent have been described, in certain embodiments, one or more other components of an electrochemical cell can include a CO₂ absorption agent. For example, an electrochemical cell may have a separator that includes a CO₂ absorption agent.

As an additional example, while electrochemical cell 10 in FIG. 1 is a primary cell, in some embodiments a secondary cell can have a cathode that includes one or more of the above-described CO₂ absorption agents. In some such embodiments, the cell can include a relatively robust separator, such as a separator that has many layers and/or that is relatively thick. The secondary cell can also be designed to accommodate for changes, such as swelling, that can occur in the cell.

All references, such as patent applications, publications, and patents, referred to herein are incorporated by reference in their entirety.

Other embodiments are within the scope of the following claims.

What is claimed is:

1. An electrochemical cell, comprising:
a cathode comprising MnO₂ and a CO₂ absorption agent;
an anode containing lithium; and
an electrolyte.

2. The electrochemical cell of claim 1, wherein the MnO₂ is gamma-MnO₂.

3. The electrochemical cell of claim 1, wherein the MnO₂ is lithiated.

4. The electrochemical cell of claim 3, wherein the MnO₂ contains from 0.1 percent to two percent lithium by weight.

5. The electrochemical cell of claim 1, wherein the lithium is a lithium alloy.

6. The electrochemical cell of claim 1, wherein the CO₂ absorption agent is a metal oxide.

7. The electrochemical cell of claim 1, wherein the CO₂ absorption agent is CaO or BaO.

8. The electrochemical cell of claim 1, wherein the CO₂ absorption agent is selected from the group consisting of Li₂O, Na₂O, and SrO.

9. The electrochemical cell of claim 1, wherein the CO₂ absorption agent is a metal hydroxide.

10. The electrochemical cell of claim 1, wherein the CO₂ absorption agent is Ca(OH)₂ or NaOH.

11. The electrochemical cell of claim 1, wherein the CO₂ absorption agent is selected from the group consisting of Mg(OH)₂, Al(OH)₃, Sr(OH)₂, and LiOH.

12. The electrochemical cell of claim 1, wherein the CO₂ absorption agent is soda lime.

13. The electrochemical cell of claim 1, wherein the electrolyte is non-aqueous.

14. The electrochemical cell of claim 13, wherein the electrolyte is selected from the group consisting of propylene carbonate and ethylene carbonate.

15. The electrochemical cell of claim 1, wherein the cathode comprises from 0.1 percent to 15 percent of the CO₂ absorption agent by weight.

16. The electrochemical cell of claim 1, wherein the cathode comprises from 0.5 percent to 10 percent of the CO₂ absorption agent by weight.

17. The electrochemical cell of claim 1, wherein the CO₂ absorption agent does not contain lithium.

18. An electrochemical cell, comprising:
a cathode comprising MnO₂ and a CO₂ absorption agent;
an anode; and
a non-aqueous electrolyte.

19. The electrochemical cell of claim 18, wherein the anode comprises an alkaline metal.

20. The electrochemical cell of claim 18, wherein the MnO₂ is lithiated.

21. The electrochemical cell of claim 18, wherein the CO₂ absorption agent is selected from the group consisting of CaO, BaO, Li₂O, Na₂O, SrO, Ca(OH)₂, NaOH, Mg(OH)₂, Al(OH)₃, Sr(OH)₂, LiOH, and soda lime.

22. The electrochemical cell of claim 18, wherein the non-aqueous electrolyte is selected from the group consisting of propylene carbonate and ethylene carbonate.

23. A cathode for an electrochemical cell, the cathode comprising MnO₂ and a CO₂ absorption agent.

24. The cathode of claim 23, wherein the CO₂ absorption agent is selected from the group consisting of CaO, BaO, Li₂O, Na₂O, SrO, Ca(OH)₂, NaOH, Mg(OH)₂, Al(OH)₃, Sr(OH)₂, LiOH, and soda lime.

25. The cathode of claim 23, wherein the MnO₂ is lithiated.

26. A method of making an electrochemical cell, the method comprising:
combining a CO₂ absorption agent with MnO₂ to provide a cathode; and
incorporating the cathode into an electrochemical cell.

27. The method of claim 26, wherein the CO₂ absorption agent is selected from the group consisting of CaO, BaO, Li₂O, Na₂O, SrO, Ca(OH)₂, NaOH, Mg(OH)₂, Al(OH)₃, Sr(OH)₂, LiOH, and soda lime.

28. The method of claim 26, further comprising:
(a) treating a gamma-MnO₂ material with LiOH and heat to provide a lithiated MnO₂;
(b) heating the lithiated MnO₂ to remove moisture; and
(c) combining the MnO₂ provided by (b) with the CO₂ absorption agent.
